(19) United States
(12) Patent Application Publication
(10) Pub. No.: US 2012/0105366 A1
(43) Pub. Date: May 3, 2012

(54) POSITIONING ALGORITHM FOR EDGE PORTION OF TOUCH PANEL AND POSITIONING SYSTEM USING THE SAME

(75) Inventors: Chih-Chang LAI, Hsinchu County (TW); Hsieh-Yi Wu, Hsinchu County (TW)

(73) Assignee: NOVATEK MICROELECTRONICS CORP., Hsinchu (TW)

(21) Appl. No.: 13/275,463

(22) Filed: Oct. 18, 2011

(30) Foreign Application Priority Data
Oct. 29, 2010 (TW) 99137337

(51) Int. Cl. G06F 3/044

(52) U.S. Cl. 345/174

(57) ABSTRACT

A positioning algorithm for edge portion of touch panel is provided. Dummy sensing lines surrounding a touch panel are provided. The x-axis and y-axis coordinate ranges of x-axis and y-axis sensing lines of the touch panel are determined. When the touch panel is touched, an x-axis sensing line, a y-axis sensing line, and a dummy sensing capacitance generated by the dummy sensing lines are located. Whether the corresponding x-axis sensing capacitance of the x-axis sensing line is smaller than or equal to the x-axis dummy sensing capacitance is determined. If so, an x-axis coordinate value is obtained according to the x-axis sensing capacitance and the dummy sensing capacitance. Whether the corresponding y-axis sensing capacitance of the y-axis sensing line is smaller than or equal to y-axis dummy sensing capacitance is determined. If so, a y-axis coordinate value is obtained according to the y-axis sensing capacitance and the dummy sensing capacitance.

This application claims the benefit of Taiwan application Serial No. 099137337, filed Oct. 29, 2010, the subject matter of which is incorporated herein by reference.

### BACKGROUND OF THE INVENTION

1. Field of the Invention

The invention relates in general to a positioning algorithm for touch panel and a position sensing system using the same, and more particularly to a positioning algorithm for the edge portion of a touch panel and a position sensing system using the same.

2. Description of the Related Art

Along with the increase in the demand for multi-touch technology, the projected capacitive touch technology has become one of the mainstream technologies in the touch panel technology. The human body is a proper conductor, and as the human body approaches a projected capacitive touch panel, the capacitance generated due to the capacitance coupling between the transparent electrode (ITO) of the projected capacitive touch panel and the human body increases. The position of the touch point can be located by detecting the variance in the static capacitance on the sensing lines of the projected capacitive touch panel.

Generally, the area of the sensing pad of the projected capacitive touch panel should be big enough for being able to provide sufficient capacitance in response to human body touch event, such that the projected capacitive touch panel only has a limited number of sensing lines. When the physical properties of the projected capacitive touch panel are taken into consideration, the area of the diamond-shaped sensing pad on the sensing lines is about 5×5 mm which is a suitable size of sensing area. There are about 12 x-axis sensing lines and 8 y-axis sensing lines disposed on a 3-inch projected capacitive touch panel. According to the existing technology, two (or more than two) sensing lines of the same direction can be located in the projected capacitive touch panel, capacitance variance is generated in response to the user's touch operation, and interpolation is performed according to the corresponding coordinate values of the two (or more than two) sensing lines to realize a touch panel with higher resolution.

However, the above interpolation of coordinate value can be realized only when a user's touch operation triggers capacitance variance on two (or more than two) sensing lines concurrently. Thus, when the user's touch operation is performed on the edge portion of a capacitive touch panel, capacitance variance occurs on only one sensing line, and the above interpolation method cannot be realized.

### SUMMARY OF THE INVENTION

The invention is directed to a positioning algorithm for touch panel and a position sensing system using the same. In comparison to the positioning algorithm and the position sensing system using the same used in a conventional touch panel, the positioning algorithm for touch panel and the position sensing system using the same disclosed in the invention have the advantage of effectively detecting the touch operation triggered in the edge portion of a touch panel by the user.

According to a first aspect of the present invention, a positioning algorithm for edge portion applied in a touch panel is provided. The positioning algorithm for edge portion includes the following steps. Firstly, a set of dummy sensing lines surrounding the touch panel are provided. Next, the x-axis and the y-axis coordinate ranges of a number of x-axis and y-axis sensing lines of the touch panel are determined in response to a predetermined resolution level. When the touch panel is touched, p x-axis sensing lines and q y-axis sensing lines generating a sensing capacitance larger than a threshold are located, wherein p and q are positive integers. When the touch panel is touched, a dummy sensing capacitance generated by the set of dummy sensing lines is located. Then, whether the corresponding x-axis sensing capacitance peak value of p x-axis sensing lines is smaller than or equal to the corresponding x-axis dummy sensing capacitance of the dummy sensing capacitance is determined. If so, the x-axis central coordinate value of the x-axis reference sensing line corresponding to the x-axis sensing capacitance peak value is used as an x-axis reference coordinate value, and the x-axis reference coordinate value is adjusted according to the ratio of the x-axis sensing capacitance peak value to the x-axis dummy sensing capacitance to obtain an x-axis coordinate value through interpolation. Whether the corresponding y-axis sensing capacitance peak value of the q y-axis sensing lines is smaller than or equal to the corresponding y-axis dummy sensing capacitance of the dummy sensing capacitance is determined. If so, the y-axis central coordinate value of the y-axis reference sensing line corresponding to the y-axis sensing capacitance peak value is used as a y-axis reference coordinate value, and the y-axis reference coordinate value is adjusted according to the ratio of the y-axis sensing capacitance peak value to the y-axis dummy sensing capacitance to obtain a y-axis coordinate value through interpolation.

According to a second aspect of the present invention, a position sensing system applied in a touch panel is provided. The position sensing system includes a set of dummy sensing lines, a sensing unit and a decision unit. The set of dummy sensing lines surround the touch panel. When the touch panel is touched, the sensing unit obtains p x-axis sensing lines and q y-axis sensing lines generating a sensing capacitance larger than a threshold, and a dummy sensing capacitance generated by the set of dummy sensing lines, wherein p and q are positive integers. The decision unit generates x-axis and y-axis dummy sensing capacitances according to the dummy sensing capacitance, and determines whether the corresponding x-axis sensing capacitance peak value of p x-axis sensing lines is smaller than or equal to the x-axis dummy sensing capacitance. If so, the decision unit uses the central coordinate value of the x-axis reference sensing line corresponding to the x-axis sensing capacitance peak value as an x-axis reference coordinate value, and adjust the x-axis reference coordinate value according to the ratio of the x-axis sensing capacitance peak value to the x-axis dummy sensing capacitance to obtain an x-axis coordinate value through interpolation. The decision unit further determines whether a corresponding y-axis sensing capacitance peak value of the q y-axis sensing lines is smaller than or equal to y-axis dummy sensing capacitance. If so, the decision unit uses a y-axis central coordinate value of the y-axis reference sensing line corresponding to the y-axis sensing capacitance peak value as a y-axis reference coordinate value, and adjusts the y-axis reference coordinate value according to the ratio of the y-axis sensing capacitance peak value to the y-axis dummy sensing capacitance to obtain a y-axis coordinate value through interpolation.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A-1C show a flowchart of a positioning algorithm for touch panel according to an exemplary embodiment of the invention;

FIG. 2 shows a schematic diagram of an example of a touch panel according to an exemplary embodiment of the invention;

FIG. 3A shows a schematic diagram of a related operation example when a touch panel is touched at a non-edge portion;

FIGS. 3B and 3C show schematic diagrams of related operation examples when a touch panel is touched at a non-edge portion;

FIGS. 4˜8 show schematic diagram of a first example to a fifth example of a touch panel according to an exemplary embodiment of the invention;

FIG. 9 shows a schematic diagram of a display device according to an exemplary embodiment of the invention; and

FIG. 10 shows a schematic diagram of another example of a touch panel according to an exemplary embodiment of the invention.

### DETAILED DESCRIPTION OF THE INVENTION

The invention provides a positioning algorithm for touch panel and a position sensing system using the same. The gap between two sensing lines is further divided into equal interpolation intervals, and the corresponding central coordinate value of the peak value sensing capacitance is used as a reference. Then, the corresponding coordinate value of the position of a touch point is obtained from the reference value and its adjacent sensing line through interpolation. Thus, the positioning algorithm for touch panel and the position sensing system using the same of the invention increase the resolution level of touch panel and can be implemented by way of hardware.

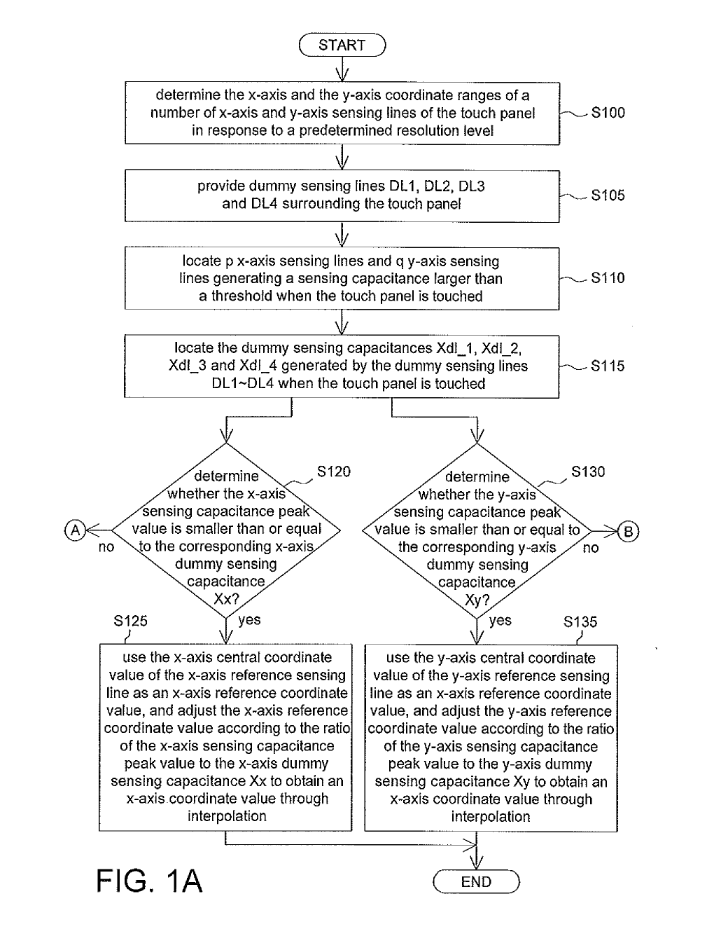

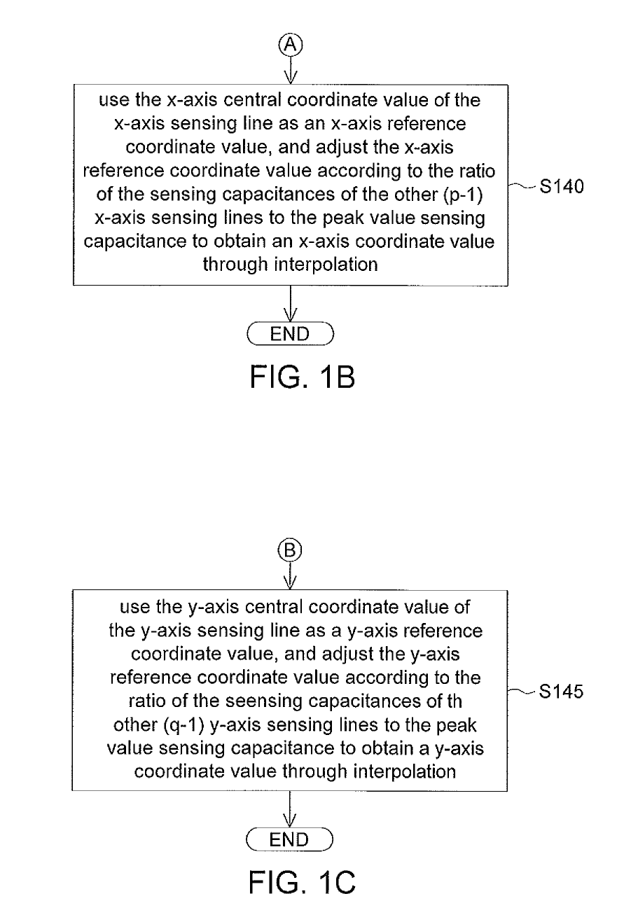

Referring to FIG. 1A, a flowchart of a positioning algorithm for touch panel according to an exemplary embodiment of the invention is shown. The positioning algorithm of the present embodiment is applied in a touch panel such as a projected capacitive touch panel.

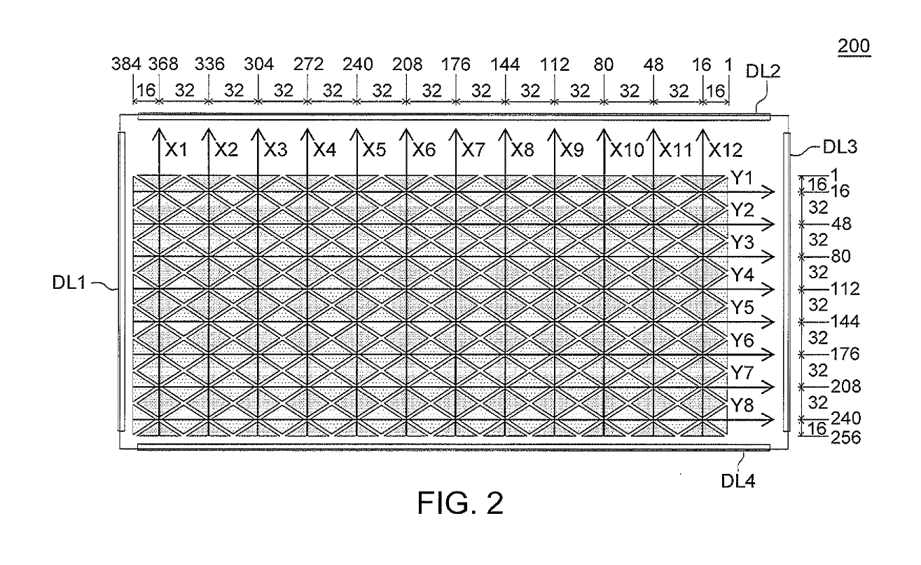

In step S100, the x-axis and the y-axis coordinate ranges of a number of x-axis and y-axis sensing lines of the touch panel are determined in response to a predetermined resolution level. Referring to FIG. 2, a schematic diagram of an example of a touch panel according to an exemplary embodiment of the invention is shown. In the following elaboration, the touch panel is exemplified by a 3-inch panel having 12 x-axis sensing lines X1˜X12 and 8 y-axis sensing lines Y1˜Y8, and the predetermined resolution level is exemplified by 384×256, but the invention is not limited thereto. As indicated in FIG. 2, each sensing line on the touch panel 200 has many diamond-shaped sensing pads, and in each sensing line, the sensing pad corresponding to the edge portion of the touch panel 200 is a triangle whose area is a half of the area of the above diamond-shaped sensing pad. Since the predetermined resolution level is 384×256, calculus of finite difference is applied between two adjacent x-axis sensing lines to obtain a 32 order (M order) x-axis coordinate value, and applied between two adjacent y-axis sensing lines to obtain a 32 order (N order) y-axis coordinate value. For example, the x-axis coordinate value of the x-axis sensing line X3 ranges 288˜320, and the x-axis central coordinate value of the x-axis sensing line X3 equals 304. The y-axis coordinate value of the y-axis sensing line Y5 ranges 128˜160, and the y-axis central coordinate value of the y-axis sensing line Y5 equals 144.

In step S105, a set of dummy sensing lines DL surrounding the touch panel are provided. In the example of FIG. 2, the set of dummy sensing lines DL includes four dummy sensing lines DL1, DL2, DL3 and DL4 formed by such as electrode material. For example, the two dummy sensing lines DL1 and DL3 substantially have the same size of area, and are respectively used as the 0-th x-axis sensing line and the 13-th x-axis sensing line other than the above 12 x-axis sensing lines X1-X12, and the ratio of the area of each of the dummy sensing lines X1-X12 to each of the 1st and the 12-th sensing lines X1 and X12 equals 1: m. In other words, in response to the same conductor approaching event, the capacitance sensing abilities of the 0-th and the 13-th x-axis sensing lines are (1/m) times of that of the 1st to the 12-th sensing lines X1˜X12, wherein m is a positive real number. The dummy sensing lines DL2 and DL4 substantially have the same size of area, and are respectively used as the 0-th y sensing line and the 9-th y-axis sensing line other than the above eight y-axis sensing lines Y1-Y8, and the ratio of the area each of the dummy sensing lines DL2 and DL4 to that of each of the 1st and the 8-th sensing lines Y1 and Y8 equals 1: n. In other words, in response to the same conductor approaching event, the capacitance sensing abilities of the 0-th and the 9-th y-axis sensing lines are (1/n) times of that of the 1st to the 9-th sensing lines Y1˜Y9, wherein n is a positive real number.

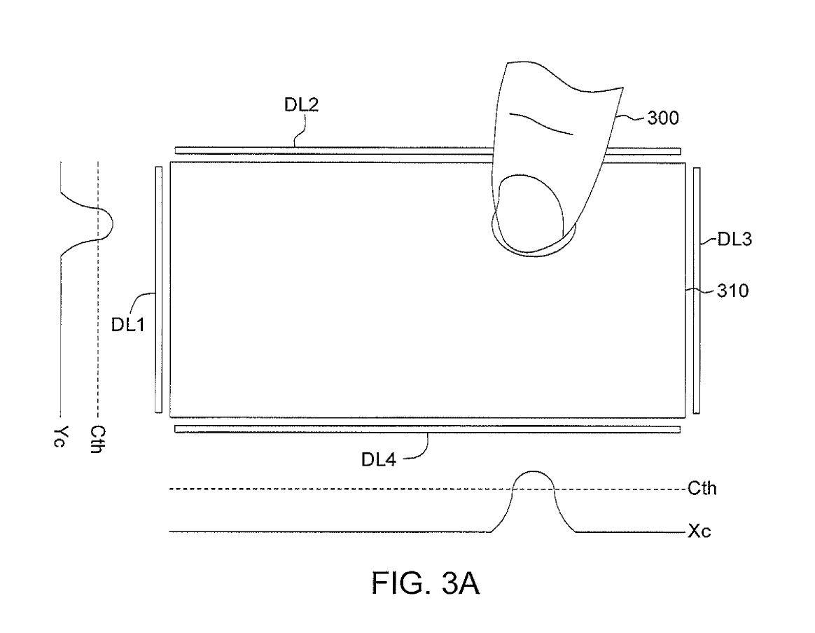

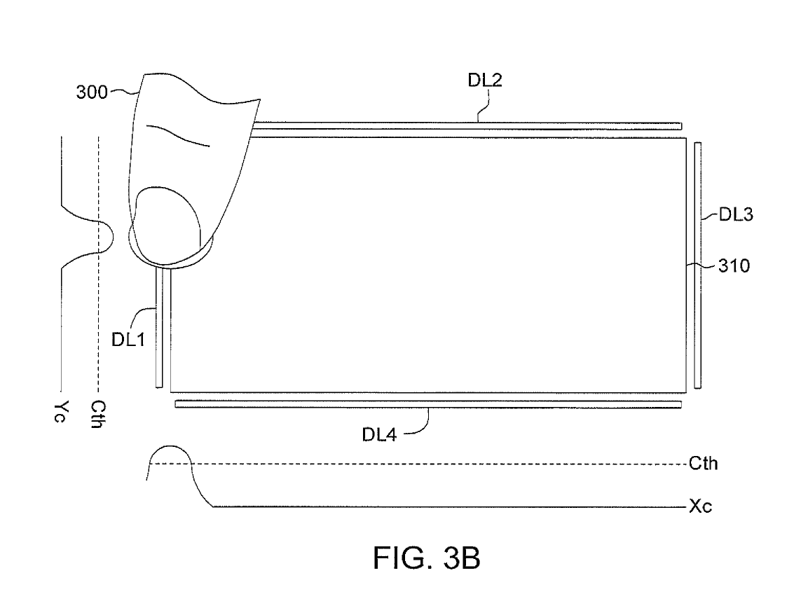

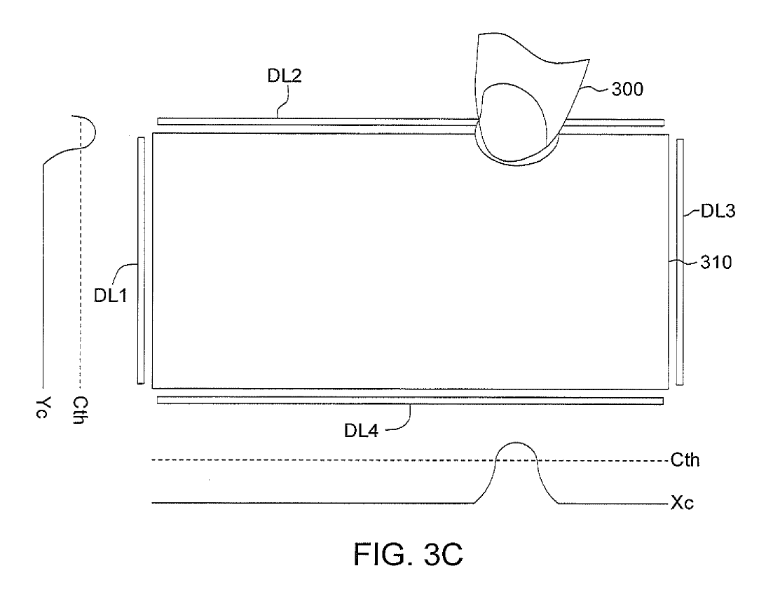

In step S110, when the touch panel is touched, p x-axis sensing lines and q y-axis sensing lines generating a sensing capacitance larger than a threshold are located, wherein p and q are positive integers. Referring to FIG. 3A, a schematic diagram of a first example of sensing a touch panel according to an exemplary embodiment of the invention is shown. FIG. 3A shows a schematic diagram of a related operation example when a touch panel is touched at a non-edge portion (for example, the corresponding x-axis coordinate value and the corresponding y-axis coordinate value respectively fall within the range of 16˜368 and the range of 16˜240). When the human body 300 approaches the touch panel 310, the capacitances Xc and Yc generated due to the capacitance coupling between the transparent electrode of the touch panel 310 and the human body 300 increase, the x-axis sensing line generating a maximum sensing capacitance larger than the threshold Cth is selected as the x-axis reference sensing line, and the y-axis sensing line generating a maximum sensing capacitance larger than the threshold Cth is selected as y-axis reference sensing line.

In other example, when the human body 300 approaches the edge portion of the touch panel 310 (for example, the corresponding x-axis coordinate value falls within the range of 0˜16 or 368˜384, and the corresponding y-axis coordinate value falls within the range of 0˜16 or 240˜256), of all x-axis and y-axis sensing lines, only one x-axis sensing line closest to the edge portion of the touch panel 310 or only one y-axis sensing line closest to the edge portion of the touch panel 310 will generate a sensing capacitance larger than the threshold as indicated in FIGS. 3B and 3C. In the examples of the like, p and q are both equal to 1, and the corresponding x-axis sensing line and the corresponding y-axis sensing line are used as the x-axis reference sensing line and the y-axis reference sensing line, which generate an x-axis sensing capacitance peak value Xmax and a y-axis sensing capacitance peak value Ymax respectively, wherein both Xmax and Ymax are larger than a threshold.

In step S115, when the touch panel is touched, the dummy sensing capacitances Xdl_1, Xdl_2, Xdl_3 and Xdl_4 generated by the dummy sensing lines DL1˜DL4 are located. Like the example of FIG. 3A in which the capacitances Xc and Yc generated due to the capacitance coupling between the transparent electrode of the touch panel 310 and the human body 300 increase when the human body 300 approaches the touch panel 310, in the example of FIGS. 3B and 3C, the capacitances Xdl_1˜Xdl_4 generated due to the capacitance coupling between the dummy sensing lines DL1˜DL4 of the touch panel 310 and the human body 300 also increase correspondingly when the human body 300 approaches the touch panel 310.

In step S120, whether the x-axis sensing capacitance peak value is smaller than or equal to the corresponding x-axis dummy sensing capacitance Xx of the dummy sensing capacitance Xdl_1˜Xdl_4 is determined. For example, the x-axis dummy sensing capacitance Xx satisfies the following equation:

Xx=Xdl_{—}1×m=Xdl_{—}3×m

Wherein, m is the ratio of the area of the dummy sensing lines DL1 and DL3 to the area of the 1st and the 12-th sensing lines X1 and X12. With the dummy sensing capacitance Xdl_1 or Xdl_3 being amplified by m times, the dummy sensing lines DL1 and DL3 used as the 0-th and the 12-th x-axis sensing lines can equivalently have substantially the same charge sensing ability with the other x-axis sensing lines X1˜X12. Thus, the x-axis dummy capacitance Xx can be used as a threshold for determining whether the position of the touch panel touched by the human body corresponding to the x-axis edge portion (such as corresponding to a region in which the x-axis coordinate value ranges 1˜16 or 368˜384).

If the x-axis sensing capacitance peak value is smaller than or equal to the x-axis threshold, this implies that the position of the touch panel touched by the human body falls within the said x-axis edge portion. Then, the positioning algorithm for edge portion is used for positioning the position of the touch panel touched by the human body. For example, the positioning algorithm for edge portion includes step S125, the x-axis central coordinate value of the x-axis reference sensing line is used as an x-axis reference coordinate value, and the x-axis reference coordinate value is adjusted according to the ratio of the x-axis sensing capacitance peak value to the x-axis dummy sensing capacitance Xx to obtain an x-axis coordinate value through interpolation.

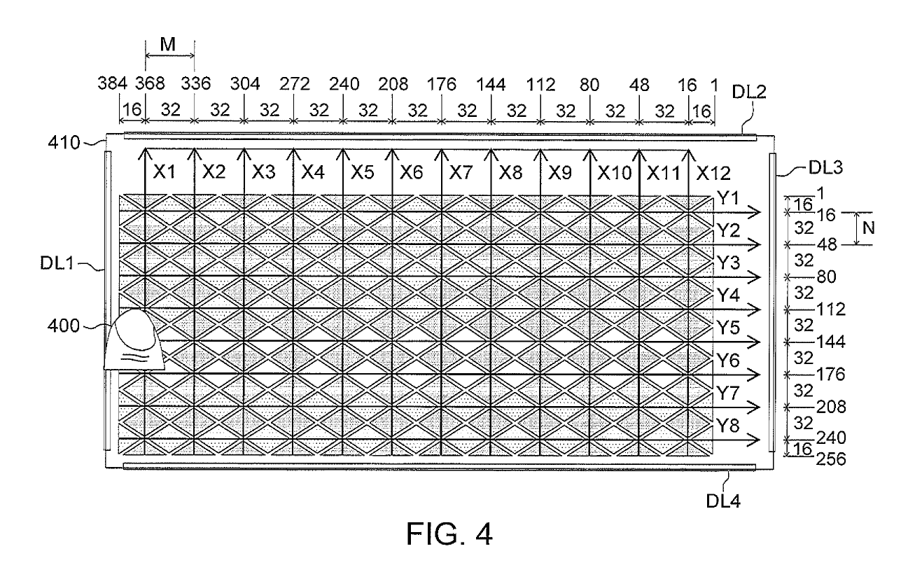

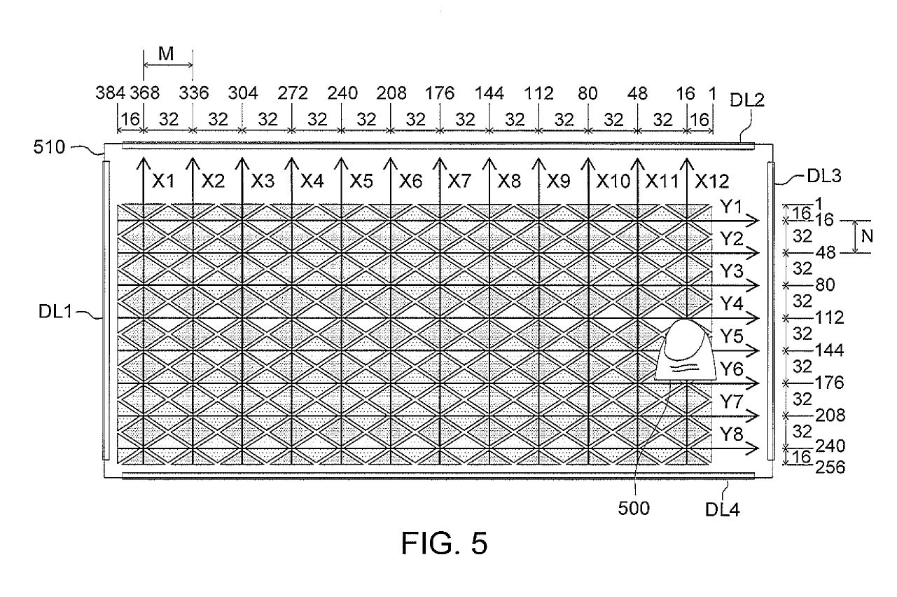

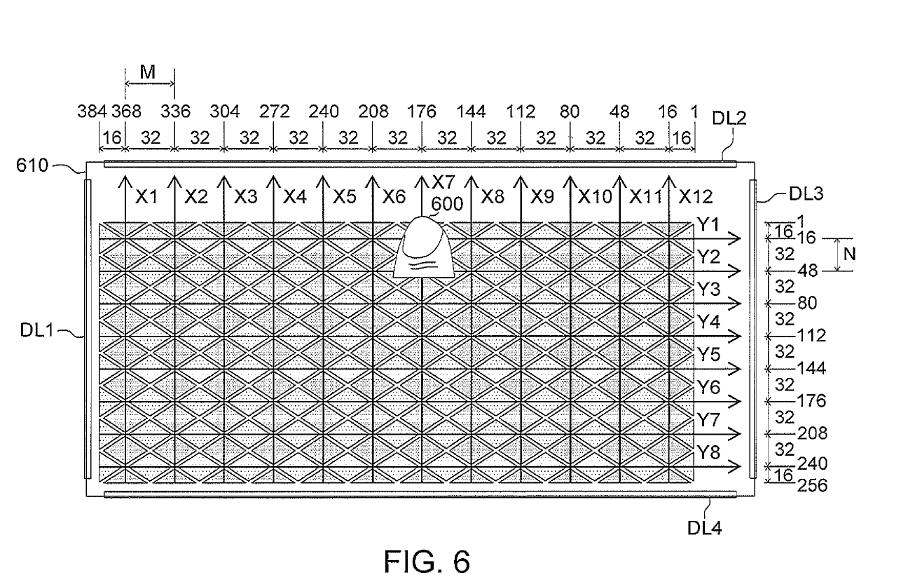

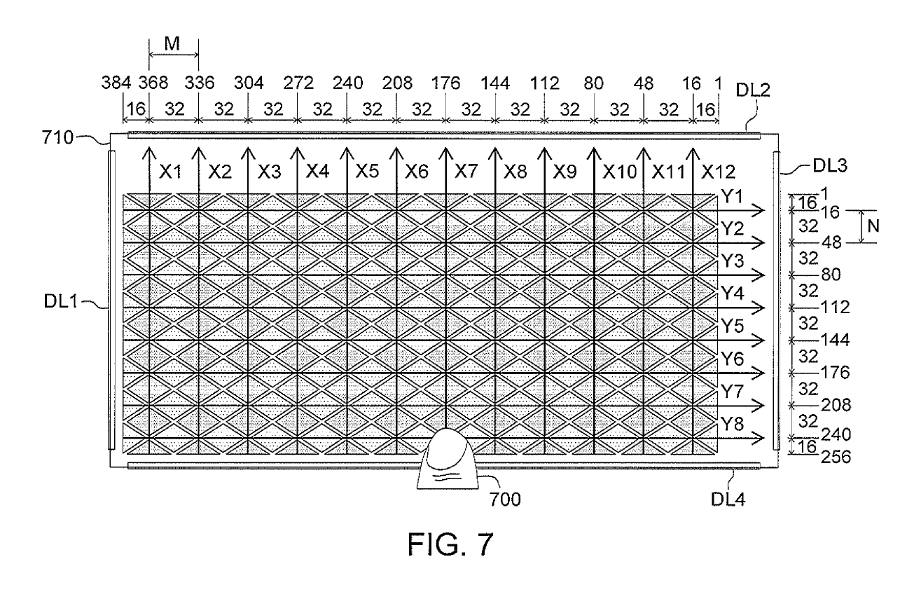

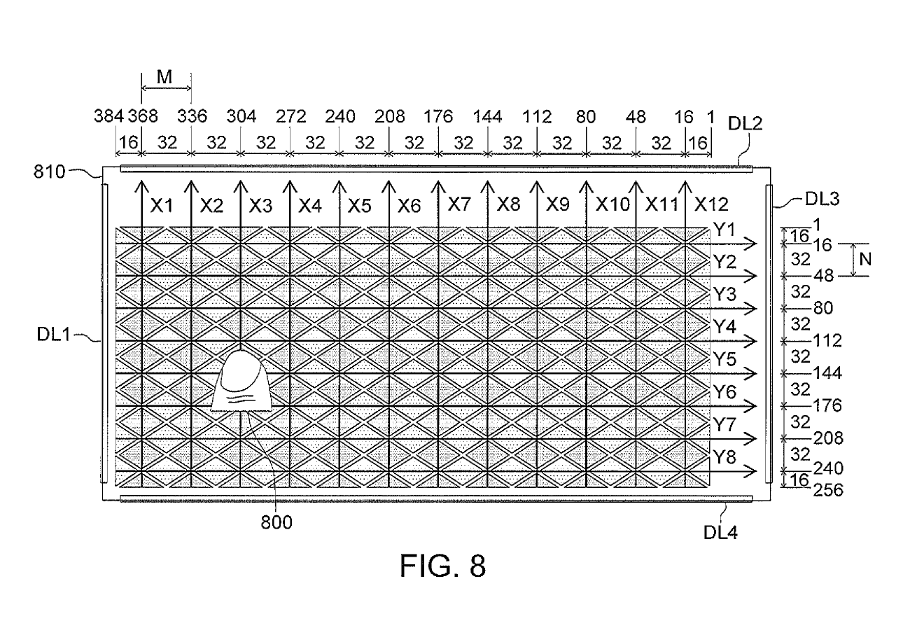

Referring to FIG. 4, a schematic diagram of a first example of sensing a touch panel according to an exemplary embodiment of the invention is shown. Wherein, M denotes the order of difference to which calculus of finite difference is applied between any two adjacent x-axis sensing lines. Let the touch panel 400 be taken for example. The x-axis sensing line with a peak value sensing capacitance is X1, so the peak value sensing capacitance is Dx1, and the x-axis reference coordinate value being the x-axis central coordinate value of the x-axis sensing line X1 equals 368. Then, the x-axis reference coordinate value 368 is adjusted according to the ratio of the x-axis sensing capacitance peak value Dx1 to the x-axis dummy sensing capacitance Xx to obtain the x-axis coordinate value x_{d} through interpolation. Referring to formula (1).

x_{d}=368+(Dx1/Xx)×(M/2) formula (1)

Referring to FIG. 5, a schematic diagram of a second example of sensing a touch panel according to an exemplary embodiment of the invention is shown, Wherein, M denotes the order of difference to which calculus of finite difference is applied between any two adjacent x-axis sensing lines. Let the touch panel 500 be taken for example. The x-axis sensing line with a peak value sensing capacitance is X12, so the peak value sensing capacitance is Dx12, and the x-axis reference coordinate value being the x-axis central coordinate value of the x-axis sensing lines X12 equals 16. Then, the x-axis reference coordinate value 16 is adjusted according to the ratio of the x-axis sensing capacitance peak value Dx12 to the x-axis dummy sensing capacitance Xx to obtain an x-axis coordinate value x_{d} through interpolation. Referring to formula (2).

x_{d}=16−(Dx12/Xx)×(M/2) formula (2)

Following step S115, step S130 is performed. In step 130, whether the y-axis sensing capacitance peak value is smaller than or equal to the corresponding y-axis dummy sensing capacitance Xy of the dummy sensing capacitance Xdl_1˜Xdl_4 is determined. For example, the y-axis dummy sensing capacitance Xy satisfies the following equation:

Xy=Xdl_{—}2×n=Xdl_{—}4×n

Wherein, n is the ratio of the area of the dummy sensing lines DL2 and DL4 to the area of the 1st and the 8-th sensing lines Y1 and Y8. With the dummy sensing capacitance Xdl_2 or Xdl_4 being amplified by n times, the dummy sensing lines DL1 and DL3 used as the 0-th and the 9-th y-axis sensing lines can equivalently have substantially the same charge sensing ability with the other y-axis sensing lines Y1˜Y8. Thus, y-axis dummy capacitance Xy can be used as a threshold for determining whether the position of the touch panel touched by the human body corresponding to the y-axis edge portion (such as corresponding to a region in which the y-axis coordinate value ranges 1˜16 or 240˜256).

If the y-axis sensing capacitance peak value is smaller than or equal to the y-axis threshold, this implies that the position of the touch panel touched by the human body falls within the said y-axis edge portion. Then, the positioning algorithm for edge portion is used for positioning the position of the touch panel touched by the human body. For example, the positioning algorithm for edge portion includes step S135, the y-axis central coordinate value of the y-axis reference sensing line is used as a y-axis reference coordinate value, and the y-axis reference coordinate value is adjusted according to the ratio of the y-axis sensing capacitance peak value to the y-axis dummy sensing capacitance Xy to obtain a y-axis coordinate value through interpolation.

Referring to FIG. 6, a schematic diagram of a third example of sensing a touch panel according to an exemplary embodiment of the invention is shown, Wherein N denotes the order of difference to which calculus of finite difference is applied between any two adjacent x-axis sensing lines. Let the touch panel 600 be taken for example. The y-axis sensing line with a peak value sensing capacitance is Y1, so the peak value sensing capacitance is Dy1; the y-axis reference coordinate value being the y-axis central coordinate value of the y-axis sensing lines Y1 equals 240. Then, the y-axis reference coordinate value 240 is adjusted according to the ratio of the y-axis sensing capacitance peak value Dy1 to the y-axis dummy sensing capacitance Xy to obtain a y-axis coordinate value through interpolation y_{d}. Referring to formula (3).

y_{d}=240+(Dy1/Xy)×(N/2) formula (3)

Referring to FIG. 7, a schematic diagram of a fourth example of sensing a touch panel according to an exemplary embodiment of the invention is shown, Wherein N denotes the order of difference to which calculus of finite difference is applied between any two adjacent x-axis sensing lines. Let the touch panel 700 be taken for example. The y-axis sensing line with a peak value sensing capacitance is Y8, so the peak value sensing capacitance is Dy8; the y-axis reference coordinate value being the y-axis central coordinate value of the y-axis sensing lines Y8 equals 16. Then, the y-axis reference coordinate value 16 is adjusted according to the ratio of the y-axis sensing capacitance peak value Dy8 to the y-axis dummy sensing capacitance Xy to obtain a y-axis coordinate value through interpolation y_{d}. Referring to formula (4).

y_{d}=16−(Dy8/Xy)×(N/2) formula (4)

Thus, despite the position of the touch panel touched by the human body falls within the x-axis or the y-axis edge portion (for example, the corresponding x-axis coordinate value falls within the range of 1˜16 or 368˜384, and the y-axis coordinate value falls within the range of 1˜16 or 240˜256), the positioning algorithm of the present embodiment of the invention still can position the above position touched by the human body according to the dummy sensing capacitances Xdl_1˜Xdl_4 located from the dummy sensing lines DL1˜DL4.

Referring to FIGS. 1B and 1C, flowcharts of a positioning algorithm for touch panel according to an exemplary embodiment of the invention are respectively shown. In step 120, if the x-axis sensing capacitance peak value is substantially larger than the corresponding x-axis dummy sensing capacitance Xx of the dummy sensing capacitance Xdl_1˜Xdl_4, this implies that the position of the touch panel touched by the human body falls within a non-edge portion of the touch panel. Likewise, in step 130, the sensing capacitance peak value is substantially larger than the corresponding y-axis dummy sensing capacitance Xy of the dummy sensing capacitances Xdl_1˜Xdl_4, this implies that the position of the touch panel touched by the human body falls within the said non-edge portion. Under such circumstances, the positioning algorithm of the present embodiment of the invention performs a non-edge portion positioning algorithm to position the position of the touch panel touched by the human body.

For example, the above non-edge portion positioning algorithm includes steps 140 and 145. In step 140, the x-axis central coordinate value of the x-axis reference sensing line is used as an x-axis reference coordinate value, and the x-axis reference coordinate value is adjusted according to the ratio of the sensing capacitances of the other (p−1) x-axis sensing lines to the x-axis sensing capacitance peak value to obtain an x-axis coordinate value through interpolation. In step 145, the y-axis central coordinate value of the y-axis reference sensing line is used as a y-axis reference coordinate value, and the y-axis reference coordinate value is adjusted according to the ratio of the sensing capacitances of the other (q−1) y-axis sensing lines to the y-axis sensing capacitance peak value to obtain a y-axis coordinate value through interpolation.

Referring to FIG. 8, a schematic diagram of a fifth example of sensing a touch panel according to an exemplary embodiment of the invention is shown. In the example of FIG. 8, when the human body 800 approaches the touch panel 810, in the x-axis direction, there are three x-axis sensing lines X2, X3 and X4 respectively generating the sensing capacitances DX2, DX3 and DX4 larger than the threshold Cth. When the human body 800 approaches the touch panel 810, in the y-axis direction, there are three y-axis sensing lines Y4, Y5 and Y6 respectively generating the sensing capacitances DY4, DY5 and DY6 larger than the threshold Cth.

In step S140, the x-axis central coordinate value of the x-axis sensing line with a peak value sensing capacitance is used as an x-axis reference coordinate value, and the x-axis reference coordinate value is adjusted according to the ratio of the sensing capacitances of the other (p−1) x-axis sensing lines to the peak value sensing capacitance to obtain an x-axis coordinate value through interpolation. Let the touch panel 800 be taken for example. As indicated in FIG. 8, the x-axis sensing line with a peak value sensing capacitance is X3, so the peak value sensing capacitance is DX3, and the x-axis reference coordinate value being the x-axis central coordinate value of the x-axis sensing line X3 equals 304. Then, the x-axis reference coordinate value 304 is adjusted according to the ratio of the sensing capacitance DX2 and DX4 of the x-axis sensing lines X2 and X4 to the peak value sensing capacitance DX3 to obtain an x-axis coordinate value through interpolation x_{d}. Referring to formula (5).

x_{d}=304+(DX2/DX3)×(M/2)−(DX4/DX3)×(M/2) formula (5)

Likewise, in step S145, the y-axis central coordinate value of the y-axis sensing line with a peak value sensing capacitance is used as a y-axis reference coordinate value, and the y-axis reference coordinate value is adjusted according to the ratio of the sensing capacitances of the other (q−1) y-axis sensing lines to the peak value sensing capacitance to obtain a y-axis coordinate value through interpolation. Let the touch panel 800 be taken for example. As indicated in FIG. 8, the y-axis sensing line with the peak value sensing capacitance is Y5, so the peak value sensing capacitance is DY5, and the y-axis reference coordinate value being the y-axis central coordinate value of the y-axis sensing lines Y5 equals 144. Then, the y-axis reference coordinate value 144 is adjusted according to the ratio of sensing capacitances DY4 and DY6 of the y-axis sensing lines Y4 and Y6 to the peak value sensing capacitance DY5 to obtain a y-axis coordinate value y_{d} through interpolation. Referring to formula (6).

y_{d}=144+(DY6/DY5)×(N/2)−(DY4/DY5)×(N/2) formula (6)

Given that the touch panel 800 contains a 12×8 matrix of sensing lines, the resolution of the touch panel 800 can be increased to the predetermined resolution level of 384×256.

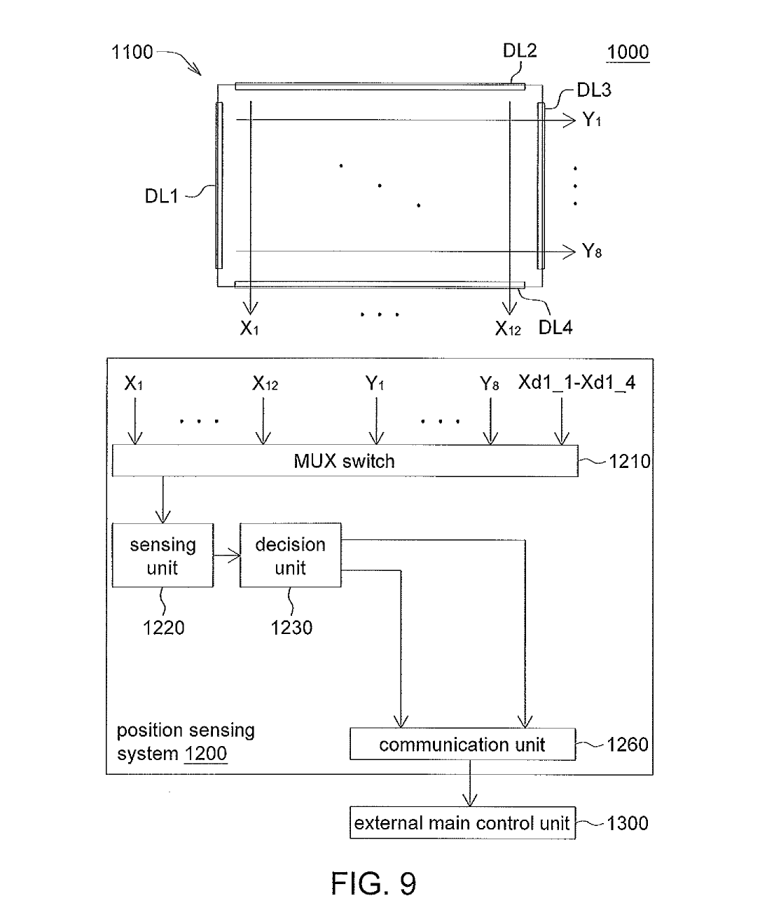

The present embodiment of the invention also discloses a position sensing system of a touch panel. Referring to FIG. 9, a schematic diagram of a display device according to an exemplary embodiment of the invention is shown. The display device 1000 includes a touch panel 1100, a position sensing system 1200 and an external main control unit 1300. The touch panel 1100 includes a number of x-axis sensing lines X1˜X12 and a number of y-axis sensing lines Y1˜Y8. The position sensing system 1200 includes an MUX switch 1210, a sensing unit 1220, a decision unit 1230 and a communication unit 1260. The MUX switch 1210 is coupled to the x-axis sensing lines X1˜X12 and the y-axis sensing lines Y1˜Y8 to receive a signal.

When the touch panel 1100 is touched, the sensing unit 1220 locates p x-axis sensing lines and q y-axis sensing lines generating a sensing capacitance larger than a threshold. The decision unit 1230 uses the central coordinate value of the x-axis reference sensing line and the y-axis reference sensing line as an x-axis reference coordinate value and a y-axis reference coordinate value, and adjusts the x-axis reference coordinate value and the y-axis reference coordinate value according to the ratio of the x-axis sensing capacitance peak value to the x-axis dummy sensing capacitance Xx or the ratio of the y-axis sensing capacitance peak value to the y-axis dummy sensing capacitance Xy respectively to obtain an x-axis coordinate value x_{d} and a y-axis coordinate value y_{d} through interpolation. The principles of operation of the sensing unit 1220 and the decision unit 1230 are similar to that disclosed in FIGS. 1A and 1B to FIG. 8, and the similarities are not repeated here.

The communication unit 1260 is the communication channel between the position sensing system 1200 and the external main control unit 1300, and can receive the command outputted from the external main control unit 1300.

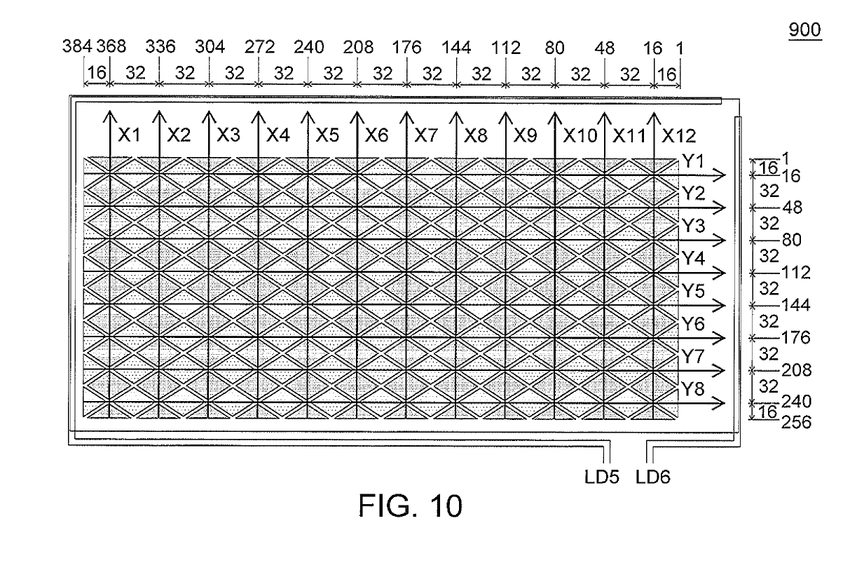

In the present embodiment of the invention, the touch panel with four dummy sensing lines LD1˜LD4 as indicated in FIG. 2 is used for exemplification purpose. However, the touch panel of the present embodiment of the invention is not limited to such exemplification. In other examples, the set of dummy sensing lines LD of the present embodiment of the invention can merely include two dummy sensing lines LD5 and LD6 as indicated in FIG. 10.

The present embodiment of the invention is related to a positioning algorithm for touch panel and the position sensing system, the dummy sensing lines are disposed surrounding the touch panel for correspondingly generating dummy sensing capacitances in response to the event that the user touches the edge portion of a touch panel. In the positioning algorithm for touch panel and the position sensing system disclosed in the present embodiment of the invention, the x-axis and y-axis coordinates corresponding to the portion touched by the user are obtained according to the dummy sensing capacitance and the x-axis and y-axis sensing capacitance peak values obtained with the x-axis and y-axis sensing lines embedded in the edge portion of the touch panel. In comparison to the positioning algorithm and the position sensing system used in a conventional touch panel, the positioning algorithm for touch panel and the position sensing system of the present embodiment of the invention are capable of effectively detecting the touch operation triggered on the edge portion of a touch panel by the user.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A positioning algorithm for edge portion applied in a touch panel, wherein the positioning algorithm for edge portion comprises:
providing a set of dummy sensing lines surrounding the touch panel;
determining the x-axis and the y-axis coordinate ranges of a plurality of x-axis and y-axis sensing lines of the touch panel in response to a predetermined resolution level;
locating p x-axis sensing lines and q y-axis sensing lines generating a sensing capacitance larger than a threshold when the touch panel is touched, wherein p and q are positive integers;
obtaining a dummy sensing capacitance generated by the set of dummy sensing lines when the touch panel is touched;
determining whether a corresponding x-axis sensing capacitance peak value of the p x-axis sensing lines is smaller than or equal to a corresponding x-axis dummy sensing capacitance of the dummy sensing capacitance: if so, an x-axis central coordinate value of the x-axis reference sensing line corresponding to the x-axis sensing capacitance peak value is used as an x-axis reference coordinate value, and the x-axis reference coordinate value is adjusted according to the ratio of the x-axis sensing capacitance peak value to the x-axis dummy sensing capacitance to obtain an x-axis coordinate value through interpolation; and
determining whether a corresponding y-axis sensing capacitance peak value of the q y-axis sensing lines is smaller than or equal to a corresponding y-axis dummy sensing capacitance of the dummy sensing capacitance: if so, a y-axis central coordinate value of the y-axis reference sensing line corresponding to the y-axis sensing capacitance peak value is used as a y-axis reference coordinate value, and the y-axis reference coordinate value is adjusted according to the ratio of they-axis sensing capacitance peak value to the y-axis dummy sensing capacitance to obtain a y-axis coordinate value through interpolation.

2. The positioning algorithm for edge portion according to claim 1, wherein calculus of finite difference is applied between any two adjacent x-axis sensing lines to obtain an M order x-axis coordinate value, and is applied between any two adjacent y-axis sensing lines to obtain an N order y-axis coordinate value, and M and N are positive integers.

3. The positioning algorithm for edge portion according to claim 1, further comprising:
using the x-axis central coordinate value of the x-axis reference sensing line as the x-axis reference coordinate value when the x-axis dummy sensing capacitance is smaller than the x-axis sensing capacitance peak value, and adjusting the x-axis reference coordinate value according to the ratio of the sensing capacitance of the other (p−1) x-axis sensing lines to the x-axis sensing capacitance peak value to obtain an x-axis coordinate value through interpolation.

4. The positioning algorithm for edge portion according to claim 1, further comprising:
using the y-axis central coordinate value of the y-axis reference sensing line as the y-axis reference coordinate value when the y-axis dummy sensing capacitance is smaller than the y-axis sensing capacitance peak value, and adjusting the y-axis reference coordinate value according to the ratio of the sensing capacitance of the other (q−1) y-axis sensing lines to the y-axis sensing capacitance peak value to obtain a y-axis coordinate value through interpolation.

5. A position sensing system applied in a touch panel, wherein the position sensing system comprises:
a set of dummy sensing lines surrounding the touch panel;
a sensing unit for obtaining p x-axis sensing lines and q y-axis sensing lines generating a sensing capacitance larger than a threshold and obtaining a dummy sensing capacitance generated by the set of dummy sensing lines when the touch panel is touched, wherein p and q are positive integers; and
a decision unit for generating an x-axis dummy sensing capacitance and a y-axis dummy sensing capacitance according to the dummy sensing capacitance and determining whether a corresponding x-axis sensing capacitance peak value of the p x-axis sensing lines is smaller than or equal to the x-axis dummy sensing capacitance: if so, the decision unit uses an x-axis central coordinate value of the x-axis reference sensing line corresponding to the x-axis sensing capacitance peak value as an x-axis reference coordinate value, and adjusts the x-axis reference coordinate value according to the ratio of the x-axis sensing capacitance peak value to the x-axis dummy sensing capacitance to obtain an x-axis coordinate value through interpolation;
wherein, the decision unit further determines whether a corresponding y-axis sensing capacitance peak value of the q y-axis sensing lines is smaller than or equal to the y-axis dummy sensing capacitance: if so, the decision unit uses a y-axis central coordinate value of the y-axis reference sensing line corresponding to the y-axis sensing capacitance peak value as a y-axis reference coordinate value, and adjusts the y-axis reference coordinate value according to the ration of the y-axis sensing capacitance peak value to the y-axis dummy sensing capacitance to obtain a y-axis coordinate value through interpolation.

6. The position sensing system according to claim 5, wherein in response to a predetermined resolution level, the sensing unit determines the x-axis and the y-axis coordinate ranges of each x-axis and each y-axis sensing lines of the touch panel.

7. The position sensing system according to claim 6, wherein the sensing unit applies calculus of finite difference between two adjacent x-axis sensing lines to obtain an M order x-axis coordinate value, and applies calculus of finite difference between two adjacent y-axis sensing lines to obtain an N order y-axis coordinate value, and M and N are positive integers.

8. The position sensing system according to claim 5, wherein when the x-axis dummy sensing capacitance is smaller than the x-axis sensing capacitance peak value, the decision unit further uses the x-axis central coordinate value of the x-axis reference sensing line as the x-axis reference coordinate value, and adjusts the x-axis reference coordinate value according to the ratio of the sensing capacitance of the other (p−1) x-axis sensing lines to the x-axis sensing capacitance peak value to obtain an x-axis coordinate value through interpolation; and
when the y-axis dummy sensing capacitance is smaller than the y-axis sensing capacitance peak value, the decision unit further uses the y-axis central coordinate value of the y-axis reference sensing line as the y-axis reference coordinate value, and adjusts the y-axis reference coordinate value according to the ratio of the sensing capacitance of the other (q−1) y-axis sensing lines to the y-axis sensing capacitance peak value to obtain a y-axis y-axis coordinate value through interpolation.
